(19) United States
(12) Patent Application Publication
(10) Pub. No.: US 2009/0199918 A1
(43) Pub. Date: Aug. 13, 2009

(54) PORTABLE AIR MANIFOLD

(76) Inventors: Craig Steinfels, Jackson, TN (US); Kyle Buzzard, Cincinnati, OH (US); James Vintzel, Jackson, TN (US)

Correspondence Address: Harness Dickey & Pierce, P.L.C., P.O. Box 828, Bloomfield Hills, MI, 48303, US

(21) Appl. No.: 12/183,811

(22) Filed: Jul. 31, 2008

Related U.S. Application Data
(63) Continuation-in-part of application No. 29/303,492, filed on Feb. 11, 2008, now abandoned.

(51) Int. Cl. F16K 17/06

(52) U.S. Cl. 137/881

(57) ABSTRACT

A portable manifold assembly that includes a manifold structure, a male quick connect coupled in fluid connection with the manifold structure, a plurality of female quick connects coupled in fluid connection to the manifold structure and a handle that is rotatably mounted on the manifold structure for rotation about a longitudinal axis of the manifold structure.

### CROSS-REFERENCE TO RELATED APPLICATIONS

This application is a continuation-in-part of co-pending U.S. Pat. Design Application Ser. No. 29/303,492 filed on Feb. 11, 2008 entitled “Pressurized Air Manifold With Regulator”, the disclosure of the aforementioned patent application(s) is/are hereby incorporated by reference as if fully set forth in its/their entirety herein.

### INTRODUCTION

The present invention generally relates to a portable air manifold.

U.S. Patent Application Publication No. 2004/0197200 discloses a manifold assembly that can be removably mounted to an air compressor assembly. The manifold assembly includes a high pressure input, two female quick connects, a pair of gauges, and a regulator that permits the user of the air compressor to reduce the pressure of the air that is dispensed through all of the female quick connects to a desired pressure. While the manifold assemblies may be daisy-chained to one another, we note that the manifold assemblies are relatively bulky, do not fully protect either the regulator or the gauges, does not protect the high pressure input or the female quick connects when the manifold assembly is not in use, and that any manifold assembly or assemblies that are connected in series with another manifold assembly receive air pressure that is dictated by any regulator that is positioned upstream.

In view of the above remarks, there remains a need in the art for an improved portable air manifold.

### SUMMARY

This section provides a general summary of some aspects of the present disclosure and is not a comprehensive listing or detailing of either the full scope of the disclosure or all of the features described therein.

In one form, the present teachings provide a portable manifold assembly with a manifold structure, a male quick connect, a plurality of female quick connects and a handle. The male quick connect is coupled in fluid connection with the manifold structure and is configured to couple the manifold structure to a source of compressed air. The female quick connects are coupled in fluid connection to the manifold structure. The handle is rotatably mounted on the manifold structure for rotation about the longitudinal axis of the manifold structure.

In another form, the present teachings provide a portable manifold assembly with a first manifold portion, which is configured to receive a supply of compressed air at a first pressure, a second manifold portion, a handle coupled to at least one of the first and second manifold portions, a regulator, and first and second female quick connects. The regulator is configured to transmit compressed air from the first manifold portion to the second manifold portion at a second pressure that is less than or equal to the first pressure. The regulator includes an adjustment knob for selectively adjusting a magnitude of the second pressure. The adjustment knob has a longitudinally extending adjustment knob axis. The first and second female quick connects each have a connector body that is arranged about a longitudinally extending connector body axis. The first female quick connect is mounted on the first manifold portion and is configured to directly receive compressed air therefrom. The second female quick connect is mounted on the second manifold portion and is configured to directly receive compressed air therefrom. The adjustment knob axis is disposed between and parallel to the longitudinally extending connector body axes of the connector bodies of the first and second female quick connects.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The drawings described herein are for illustrative purposes only and are not intended to limit the scope of the present disclosure in any way. The drawings are illustrative of selected teachings of the present disclosure and do not illustrate all possible implementations. Similar or identical elements are given consistent identifying numerals throughout the various figures.

FIG. 1 is a perspective view of a system for communicating compressed air which employs a portable manifold assembly constructed in accordance with the teachings of the present disclosure;

FIG. 2 is a perspective view of the portable manifold assembly of FIG. 1;

FIG. 3 is an exploded perspective view of the portable manifold assembly of FIG. 1;

FIG. 4 is a perspective view of a portion of the portable manifold assembly of FIG. 1 illustrating the manifold structure, handle and regulator in more detail;

FIG. 5 is a perspective view of a portion of the portable manifold assembly of FIG. 1 illustrating the handle in more detail;

FIG. 6 is a perspective view of the portable manifold assembly of FIG. 1 as coupled to the framing of a house under construction;

FIG. 7 is a perspective view of the portable manifold assembly of FIG. 1 illustrating the handle in a storage position;

FIG. 8 is a perspective view of another portable manifold assembly constructed in accordance with the teachings of the present disclosure; and

FIG. 9 is an exploded perspective view of the portable manifold assembly of FIG. 8.

### DETAILED DESCRIPTION OF THE VARIOUS EMBODIMENTS

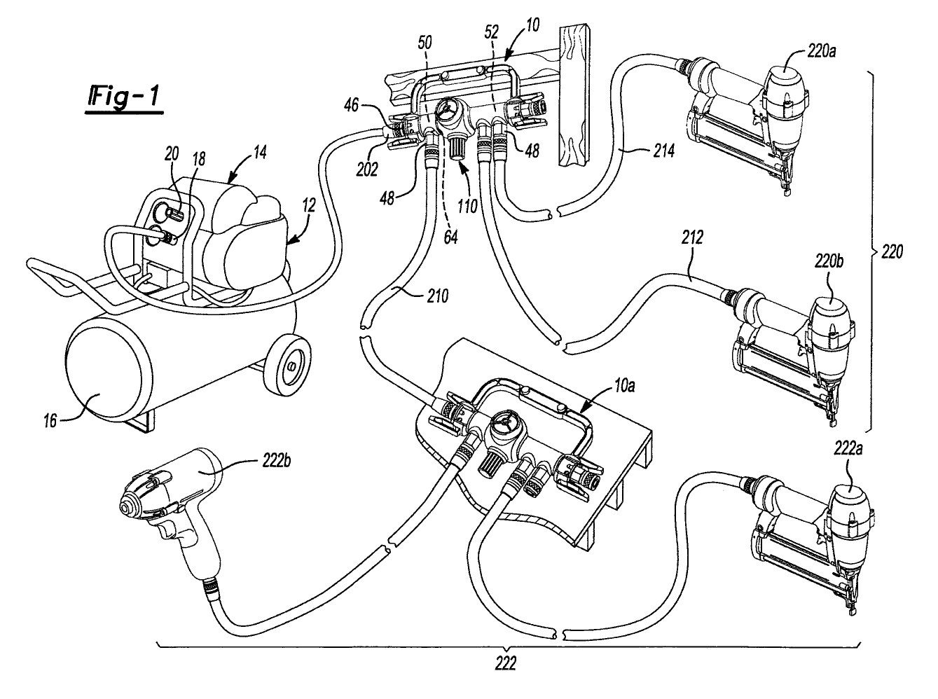

With reference to FIG. 1 of the drawings, a pair of portable manifold assemblies 10 and 10a constructed in accordance with the teachings of the present disclosure are shown in operative associated with an air compressor 12. The air compressor 12 can be a portable air compressor, such as a D55155 or D55167 air compressor marketed by DeWalt Industrial Tool Company of Towson, Md. Aspects of the D55155 compressor are disclosed in U.S. Pat. No. 6,991,437, the disclosure of which is hereby incorporated by reference as if fully set forth in detail herein. Briefly, the air compressor 12 can include a compressor 14 for producing high pressure compressed air, an air tank 16 in fluid communication with the compressor 14 for storing the high pressure compressed air, an output fitting 18 and a regulator 20. The regulator 20 can be coupled to the air tank 16 and the output fitting 18 and can be employed to permit a pressure of the compressed air that is output through the output fitting 18 to be at or below a selected pressure.

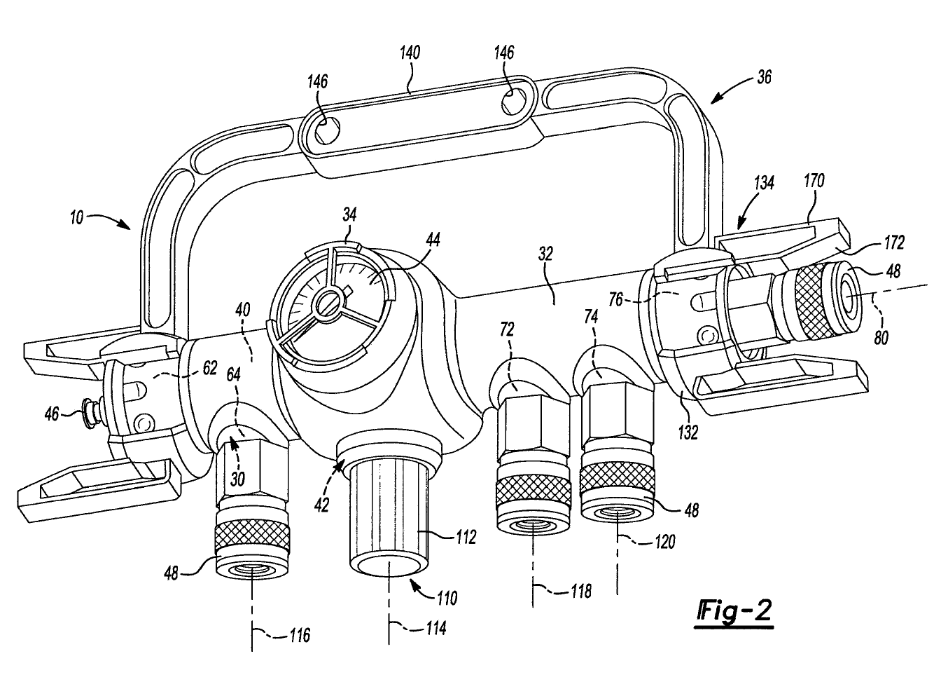

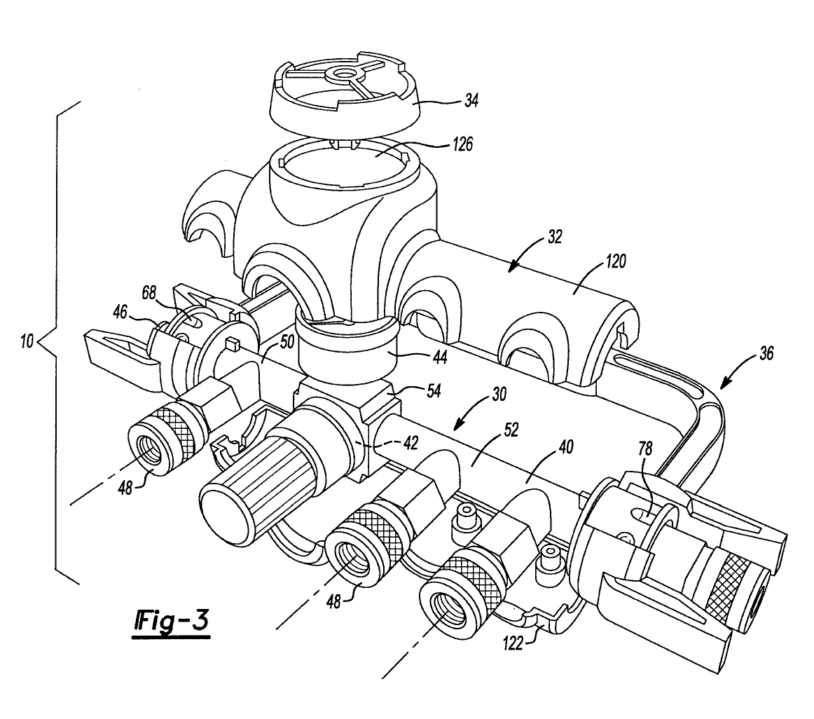

In the example provided, the manifold assembly 10a is identical to the manifold assembly 10 and as such, a discussion of the manifold assembly 10 will suffice for both. With reference to FIGS. 2 through 4, the manifold assembly 10 can include a manifold subassembly 30, a housing 32, a bezel 34 and a handle 36. The manifold subassembly 30 can include a manifold structure 40, a regulator valve 42, a regulator gauge 44, a male quick connect 46 and a plurality of female quick connects 48. The male and female quick connects 48 and—can be conventional quick connects that are commercially available from various sources. For example, the male quick connect 46 can be a 634059-00 fitting from DeWalt Industrial Tool Company of Towson, Md. or a 1PTA7 coupler plug from W.W. Grainger of Lake Forest, Ill., while the female quick connects 48 can be a 5130199-00 coupler from DeWalt Industrial Tool Company of Towson, Md. or a 1HUC5 coupler from W.W. Grainger of Lake Forest, Ill.

The manifold structure 40 can be unitarily formed in an appropriate casting process and can include a first manifold portion 50, a second manifold portion 52, and a regulator body 54 that can be disposed between the first and second manifold portions 50 and 52 to facilitate fluid communication therebetween. The first manifold portion 50 can include a first conduit 60, first and second bosses 62 and 64, respectively, that can be disposed in fluid communication with the first conduit 60, and a first hub 68 that can be coaxially disposed on an end of the first conduit 60 opposite the regulator body 54. The second manifold portion 52 can include a second conduit 70, third, fourth and fifth bosses 72, 74 and 76, respectively, and a second hub 78 that can be coaxially disposed on an end of the second conduit 70 opposite the regulator body 54. Each of the bosses 62, 64, 72, 74 and 76 can be configured to fixedly and sealingly engage a corresponding one of the male and female quick connects 46 and 48. In the example provided, the first boss 62 and the fifth boss 76 are co-axial with the first and second conduits 60 and 70, respectively, the second, third and fourth bosses 64, 72 and 74 are generally perpendicular to a longitudinal axis 80 of the manifold structure 40, and each of the bosses 62, 64, 72, 74 and 76 includes a plurality of tapered pipe threads 84 that engage corresponding tapered pipe threads (not specifically shown) formed on the male and female quick connects 46 and 48. The first and second hubs 68 and 78 can be generally similar and as such, a discussion of the second hub 78 will suffice for both. The second hub 78 can include an outer annular surface 90 that can include a first detent member 92 and a first retention member 94. In the particular example provided, the first detent member 92 includes a plurality of circumferentially spaced apart detent recesses, while the first retention member 94 includes a pair of annular walls. The male quick connect 46 can be coupled to the first boss 62 and the female quick connects 48 can be coupled to the remaining bosses 64, 72, 74 and 76.

The regulator valve 42 can be mounted to the regulator body 54 to form a regulator 110 that is configured to permit an operator of the manifold assembly 10 to selectively reduce the pressure of the air that flows from the first conduit 60 through the valve body 54 to the second conduit 70. The regulator valve 42 can include an adjustment knob 112 that may be rotated about an adjustment knob axis 114 to set the regulator valve 42 to a desired pressure. The adjustment knob axis 114 can be generally parallel to axes 116, 118 and 120 of the female quick connects 48 that are coupled to the second, third and fourth bosses 64, 72 and 74 such that the adjustment knob 112 is in a juxtaposed relationship with the female quick connects 48 coupled to the second and third bosses 64 and 72. The ends of the adjustment knob 112 and female quick connects 48 coupled to the second and third bosses 64 and 72 on a side opposite the manifold structure 40 can be spaced apart from a longitudinal axis 80 of the manifold structure 40 by a distance that is about equal. Configuration in this manner permits the female quick connects 48 coupled to the second and third bosses 64 and 72 to shroud the adjustment knob 112. The regulator gauge 44 can be coupled to the regulator body 54 and can be configured to display a pressure of the air that is disposed in the second conduit 70.

The housing 32 can be configured to shroud all or a portion of the manifold subassembly 30. In the particular example provided, the housing 32 includes a pair of clam shell halves 120, 122 into which the manifold structure 40, the regulator valve 42 and the regulator gauge 44 are received. The clam shell halves 120, 122 can extend longitudinally along the manifold structure 40 between the first and second hubs 68 and 78 and can be coupled to one another via a plurality of threaded fasteners (not specifically shown). The housing 32 can define a gauge opening 126 through which the regulator gauge 44 may be viewed.

The bezel 34 can be coupled to the housing 32 and can cover the gauge opening 126 to shield the regulator gauge 44 in a manner that permits the regulator gauge 44 to be viewed. In the example provided, the bezel 34 is fixedly coupled to the housing 32 via a snap-fit, but it will be appreciated that the bezel 34 could be rotatably mounted to the housing 32. Alternatively, the bezel 34 could be unitarily formed with the housing 32.

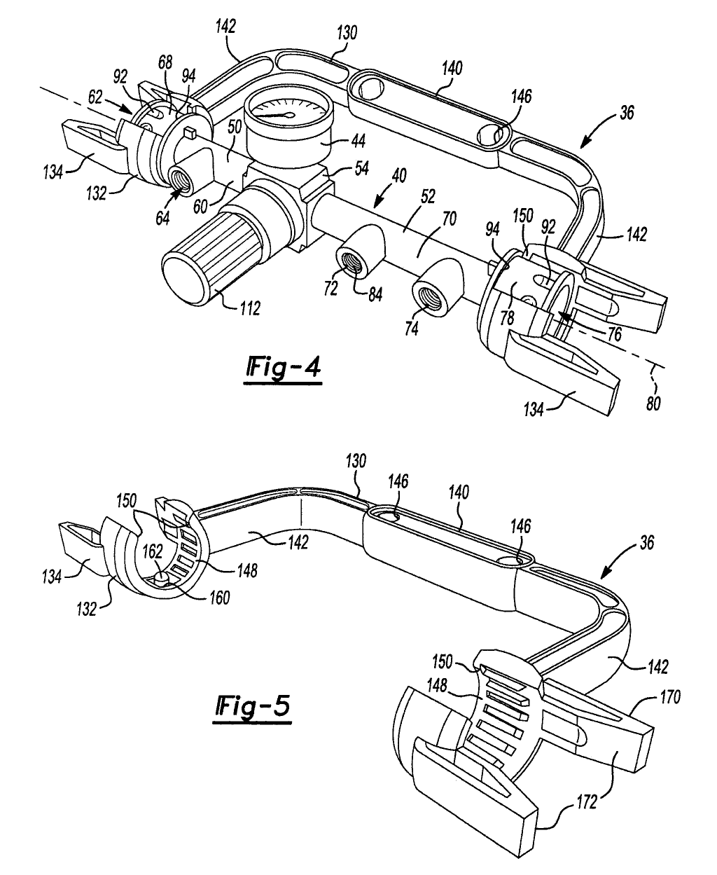

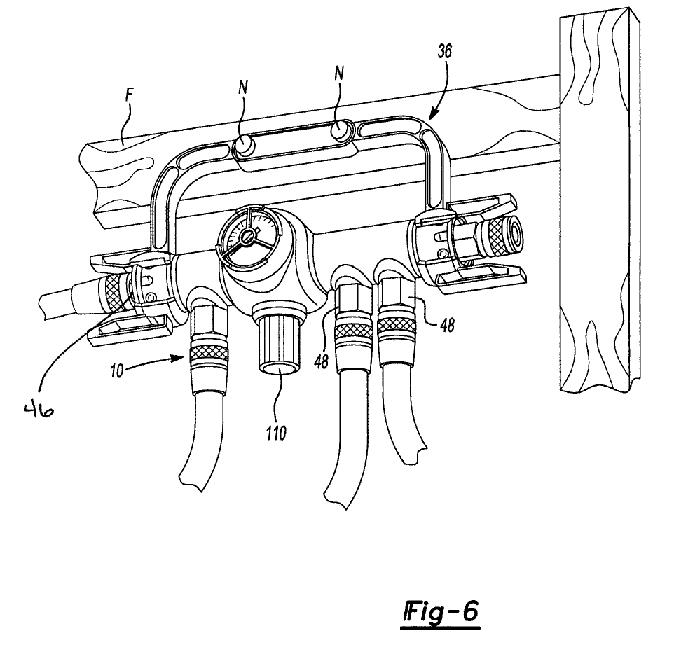

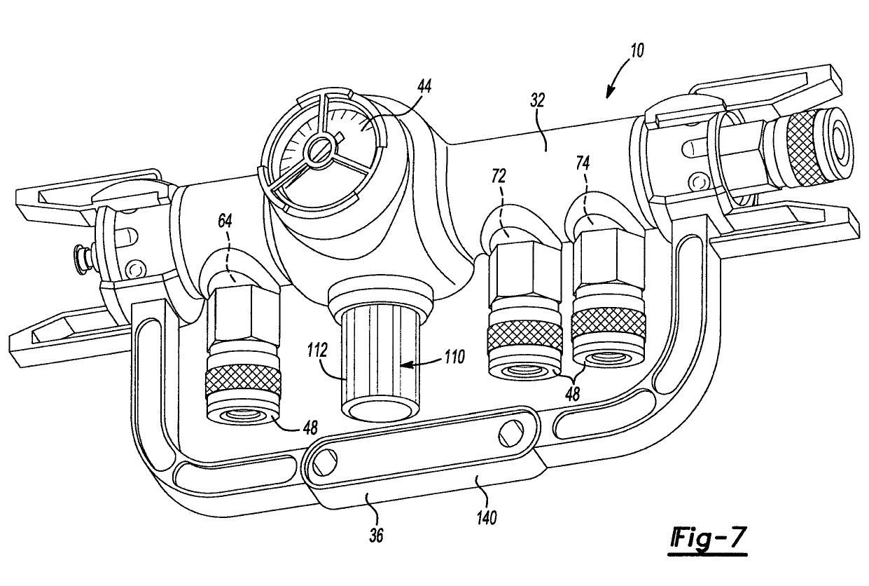

With reference to FIGS. 4 and 5, the handle 36 can include a generally U-shaped member 130, a pair of collars 132 and a pair of shrouds 134. The U-shaped member 130 can have a central body 140 and a pair of arms 142. The central body 140 can include one or more mounting holes or apertures 146 that can be sized to receive a common nail N or threaded fastener to permit a user to secure the handle 36 in a desired area (e.g., to the wood framing F of a house that is under construction as illustrated in FIG. 6). Each of the collars 132 can be coupled to an associated one of the arms 142 on a side opposite the central body 140. The collars 132 can be generally C-shaped and can define an opening 148. The collars 132 can be configured to engage a corresponding one of the first and second hubs 68 and 78 so as to be rotatable thereon. In the particular example provided, each collar 132 includes a second retention member 150 that is configured to engage a corresponding one of the first retention members 94 to limit axial movement of the handle 36 relative to the manifold structure 40. In the example provided, the second retention member 150 includes an annular rib that is disposed on opposite sides of the opening 148; the annular rib of the second retention members 150 can be abutted against the annular walls of the first retention members 94 on an associated one of the first and second hubs 68 and 78. Contact between the annular ribs 152 of the collars 132 and the walls of the first retention members 94 formed in the first and second hubs 68 and 78 limits axial movement of the handle 36 relative to the manifold structure 40. The collars 132 can include a second detent member 160 that can matingly engage the first detent member 92 on one or both of the first and second hubs 68 and 78 to resist rotation of the handle 36 relative to the manifold structure 40. The second detent member(s) 160 can be a post-like structure having a tip 162, which can be defined by a spherical radius. The tip 162 can be received into one of the recesses of the first retention member 92 formed on the first hub 68 and/or the second hub 78 and which can be disposed in-line with the opening 148 in the collar 132 generally perpendicular to the arms 142. Application of sufficient torque to the collars 132 can cause the tip 162 of each second detent member 160 to cam out of a first one of the recess of the first retention member 92 so that the handle 36 can rotate relative to the manifold structure 40. Alignment with the tip 160 to another one of the recesses of the first retention member 92 permits the second detent member 160 to resiliently cam into the another one of the recesses of the first retention member 92 so that the second detent member 160 re-engages the first detent member 92 to resist relative rotation between the handle 36 and the manifold structure 40. Accordingly, it will be appreciated that the handle 36 can be selectively positioned relative to the manifold structure 40 in a first working position, which is shown in FIG. 1, a storage position, which is shown in FIG. 7, and a second working position, in which the central body 140 is disposed at a location between the first working position and the storage position. It will be appreciated that the central body 140 of the handle 36 can shroud the ends of the adjustment knob 112 and the female quick connects 48 that are coupled to the second, third and fourth bosses 64, 72 and 74 when the handle 36 is disposed in the storage position, and that the handle 36 can shroud the regulator gauge 44, the housing 32 and/or the regulator 110 when positioned in the second working position.

With reference to FIGS. 2 and 5, each of the shrouds 134 can extend from handle 36 so as to cover a portion of the male quick connect 46 or female quick connect 48 that are mounted coaxially with the manifold structure 40. In the particular example provided, the each shroud 134 includes a pair of axially extending tabs 170 that are mounted to the collar 132 such that the opening 148 in the collar 132 is disposed between the axially extending tabs 170. A portion 172 of each tab can diverge away from the longitudinal axis 80 of the manifold structure 40 with increasing distance from the collar 132. If desired, the each shroud 134 can form a strain relief that inhibits flexing of an air hose (not shown) that can be coupled to a fitting (i.e., the male quick connect 46 or the female quick connect 46) that is coupled to the first boss 62 or the fifth boss 76.

Returning to FIG. 1, a first air hose 200 can be employed to couple the manifold assembly 10 to the air compressor 12. More specifically, the air hose 200 can include a female quick connect 202 that can be coupled to the male quick connect 46 to supply compressed air to the first manifold portion 50 at a first pressure. A second air hose 210 can be coupled to the female quick connect 46 that is coupled to the second boss 64 to supply compressed air to another device (such as another manifold assembly 10a) at the first pressure. The regulator 110 can be adjusted to supply compressed air to the second manifold portion 52 at a pressure that is equal to or lower than the first pressure. Additional air hoses 212 and 214 can be employed to couple the second manifold portion 52 to other pneumatically-powered devices to provide compressed air at the second pressure.

Configuration of the manifold assembly 10 with a regulator 110, a female quick connect 48 that is positioned prior to the regulator 110 and female quick connects 48 that are positioned after the regulator 110 provides significant flexibility in the configuration of a system for routing compressed air to a work site. In the example illustrated, a first set of tools 220 is clustered around the manifold assembly 10, while a second set of tools 222 is clustered around the manifold assembly 10a. As shown, the first set of tools 220 includes a plurality of tools 220a that require compressed air having a relatively low pressure, while the second set of tools 222 includes some tools 222a that require compressed air having a relatively low pressure and a tool 222b that requires compressed air having a relatively high pressure. The use of a female quick connect 48 that receives compressed air directly from the first manifold portion 50 in both of the manifold assemblies 10 and 10a permits compressed air to be delivered to the tool 222b that requires relatively higher pressure compressed air even though the air is routed from the air compressor 12 through two manifold assemblies 10 and 10a.

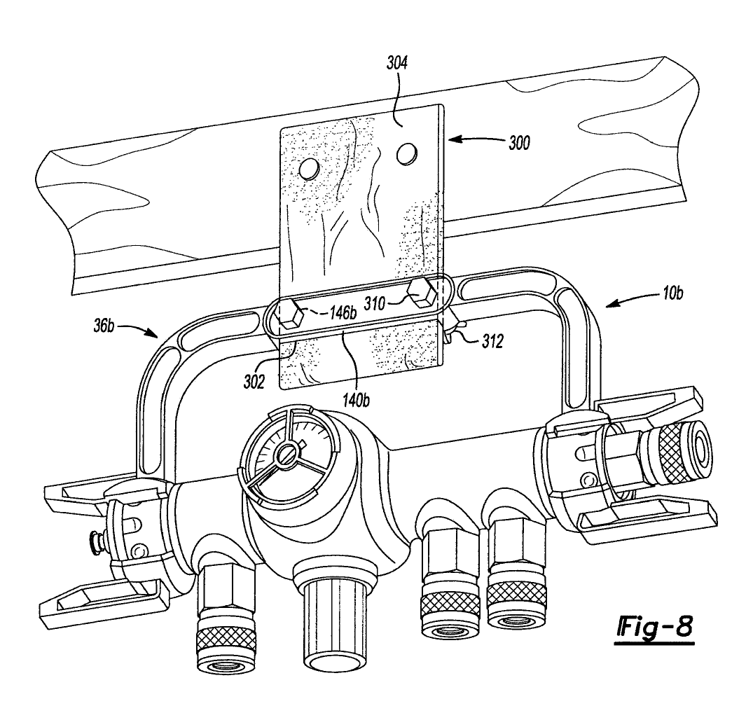

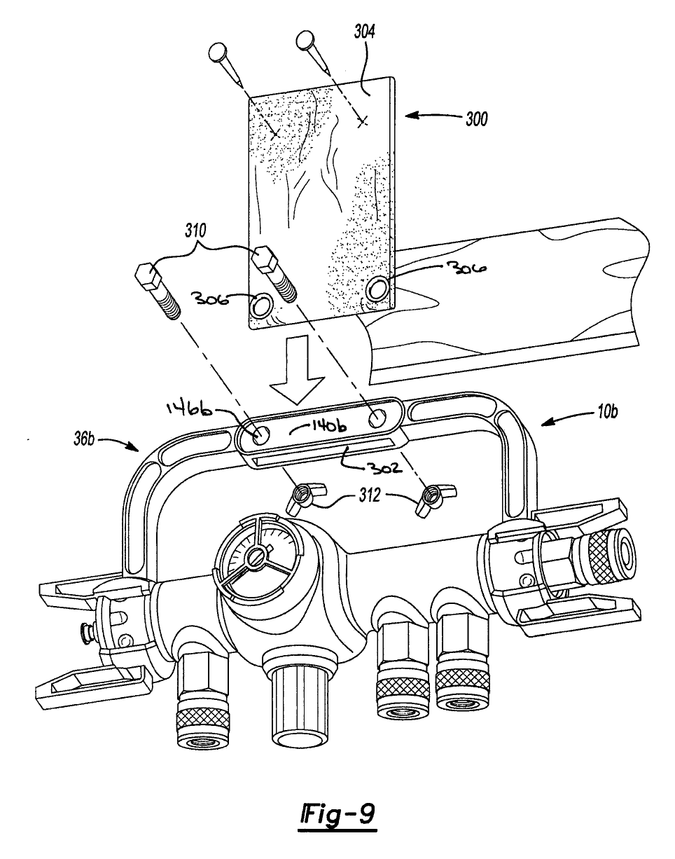

With reference to FIGS. 8 and 9, another manifold assembly 10b constructed in accordance with the teachings of the present disclosure is illustrated. The manifold assembly 10b can be generally identical to the manifold assembly 10 described above and illustrated in FIG. 1, except that the handle 36b includes an auxiliary mount 300 for removably coupling the manifold assembly 10b to a structure, such as the framing of a house under construction.

In the example provided, a longitudinally extending slot 302 is formed in the central body 140b of the handle 36b and the auxiliary mount 300 includes a nail plate or pad 304 with a pair of grommets 306. The pad 304 can be formed of an appropriately durable material, such as leather, a thin gauge sheet steel or a structural, tear-resistant plastic, and is sized to be received though the longitudinally extending slot 302. The grommets 306 can be aligned to the apertures 146b in the central body 140b and fasteners can be employed to fixedly but removably couple the auxiliary mount 300 to the handle 36. In the present example, the fasteners include bolts 310, which can be received through the apertures 146b and the grommets 306, and nylock nuts 312 that can be threadably engaged to the bolts 310. In operation, a use may employ fasteners, such as nails dispensed from a pneumatic nailer, to directly fasten the pad 304 to the structure to thereby fixedly secure the manifold assembly 10b to the structure. When it is desired that the manifold assembly 10b be decoupled from the structure, the fasteners in the pad 304 (that couple the pad 304 to the structure) may be removed or a portion of the pad 304 that includes the fasteners (that couple the pad 304 to the structure) may be cut from a remainder of the pad 304.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A portable manifold assembly comprising:
a manifold structure having a longitudinal axis;
a male quick connect coupled in fluid connection with the manifold structure, the male quick connect being adapted to couple the manifold structure to a source of compressed air;
a plurality of female quick connects coupled in fluid connection to the manifold structure; and
a handle rotatably mounted on the manifold structure for rotation about the longitudinal axis of the manifold structure.

2. The portable manifold assembly of claim 1, wherein a set of detent members are coupled to the manifold structure and a mating detent member is coupled to the handle, the mating detent member being configured to resiliently engage the set of detent members to resist rotation of the handle relative to the manifold structure.

3. The portable manifold assembly of claim 2, wherein the set of detent members includes a plurality of recesses.

4. The portable manifold assembly of claim 1, wherein the handle includes a central U-shaped portion and a pair of collars, the central U-shaped portion having a body and a pair of spaced-apart arms that extend from the body, each of the collars being coupled to an associated one of the arms opposite the body and being received about the manifold structure.

5. The portable manifold assembly of claim 4, wherein the male quick connect is coaxial with the manifold structure.

6. The portable manifold assembly of claim 5, wherein the handle further comprises a shroud that extends from one of the collars to at least partially shield the male quick connect.

7. The portable manifold assembly of claim 6, wherein the shroud includes a pair of axially extending tabs.

8. The portable manifold assembly of claim 4, wherein one of the female quick connects is coaxial with the manifold structure.

9. The portable manifold assembly of claim 8, wherein the handle further comprises a shroud that extends from one of the collars to at least partially shield the one of the female quick connects.

10. The portable manifold assembly of claim 9, wherein the shroud includes a pair of axially extending tabs.

11. The portable manifold assembly of claim 4, wherein at least one mounting hole is formed through the body.

12. The portable manifold assembly of claim 4, wherein at last one of the collars includes a retention member that engages a mating retention member that is formed on the manifold structure to inhibit movement of the handle relative to the manifold structure about the longitudinal axis of the manifold structure.

13. The portable manifold assembly of claim 12, wherein one of the retention member and the mating retention member includes a circumferentially extending rib and the other one of the retention member and the mating retention member includes a groove into which the circumferentially extending rib is received.

14. The portable manifold assembly of claim 1, wherein the manifold structure includes a first manifold member, a second manifold member and a regulator housing that is disposed between and in fluid communication with the first and second manifold members.

15. The portable manifold assembly of claim 14, wherein the first and second manifold members and the regulator housing are integrally formed.

16. The portable manifold assembly of claim 14, wherein a first one of the plurality of female quick connects is coupled to the first manifold member and is adapted to receive pressurized air directly therefrom and a second one of the plurality of female quick connects is coupled to the second manifold member and adapted to receive pressurized air directly therefrom.

17. The portable manifold assembly of claim 1, further comprising a housing having first and second shell members that are received over the manifold structure.

18. The portable manifold assembly of claim 18, wherein the manifold structure includes a regulator and a gauge, wherein the gauge is visible through an opening in the housing and wherein a bezel is coupled to the housing to at least partially cover the opening and protect the gauge.

19. The portable manifold assembly of claim 1, further comprising a perishable nail plate coupled to the handle.

20. A portable manifold assembly comprising:
a first manifold portion adapted to receive a supply of compressed air at a first pressure;
a second manifold portion;
a handle coupled to at least one of the first and second manifold portions;
a regulator configured to transmit compressed air from the first manifold portion to the second manifold portion at a second pressure that is less than or equal to the first pressure, the regulator including an adjustment knob for selectively adjusting a magnitude of the second pressure, the adjustment knob having a longitudinally extending adjustment knob axis;
first and second female quick connects each having a connector body that is arranged about a longitudinally extending connector body axis, the first female quick connect being mounted on the first manifold portion and being configured to directly receive compressed air therefrom, the second female quick connect being mounted on the second manifold portion and being configured to directly receive compressed air therefrom;
wherein the adjustment knob axis is disposed between and parallel to the longitudinally extending connector body axes of the connector bodies of the first and second female quick connects.
